(19) United States
(12) Patent Application Publication
(10) Pub. No.: US 2010/0257093 A1
(43) Pub. Date: Oct. 7, 2010

(54) Method to facilitate credit and savings

(76) Inventor: Luis Antonio Cervera, Scottsdale, AZ (US)

Correspondence Address: LUIS ANTONIO CERVERA, 3500 N. HAYDEN RD, #302, SCOTTSDALE, AZ, 85251, US

(21) Appl. No.: 12/798,528

(22) Filed: Apr. 6, 2010

Related U.S. Application Data
(60) Provisional application No. 61/212,107, filed on Apr. 7, 2009.

(51) Int. Cl. G06Q 40/00; G06Q 90/00

(52) U.S. Cl. 705/39; 705/35; 705/500

(57) ABSTRACT

This method brings together users by use of microprocessor based machines over an online network in order to participate as a group in the acquisition of assets through cooperation. The proposed invention builds upon the Rotating Savings and Credit Association (ROSCA); removing its inherent limitations as well as provide essential services for commercial use.

This application claims priority to prior U.S. provisional application No. 61/212,107, filed Apr. 7, 2009, entitled Method to Facilitate Credit and Savings, which is incorporated herein in its entirety by this reference made thereto.

### FIELD OF INVENTION

The invention relates generally to microfinance and a social network. The proposed invention provides a method of facilitating credit and savings as a rotating credit and savings association over an online network by use of microprocessor based machines.

### BACKGROUND OF INVENTION

With its roots found around the world, the Rotating Savings and Credit Association (ROSCA) is regularly used by millions in private group settings as a means of mobilizing credit and savings at the grassroots level. This method has been in use in private groups for centuries and its widespread use and success can be attributed to the great benefits it provides its participants. ROSCAs are a nontraditional means for its participants to acquire assets through the power of cooperation.

While traditional ROSCAs offer many benefits for its users, there are several inherent limitations which limit its use and scalability. The proposed invention removes the limitations of the traditional ROSCA, thus introducing many great improvements to the traditional model as well as scalability into the system.

### BRIEF SUMMARY OF INVENTION

A method and apparatus are described for conducting Rotating Credit and Savings Associations (ROSCAs) over an online network through the use of microprocessor based machines as well as key improvements to the traditional ROSCA method. The traditional method has several key limitations which inhibit its ability to be offered commercially.

Two key disadvantages to the traditional model are a lack of trust between its participants and an inefficient infrastructure. The proposed invention has overcome both of these shortcomings by streamlining the entire process over an online network; increasing its ease of use as well as allowing participants from distinct geographical locations to participate together. A proprietary risk rating algorithm will be employed creating a standard of trust among users.

In addition, the proposed invention will improve upon the traditional method by employing important services such as credit reporting of all transactions which will help participants use the proposed invention for the improvement of credit scores.

### BRIEF DESCRIPTION OF THE DRAWINGS

FIG. 1 is a schematic flow diagram illustrating a preferred method of creating the method network in accordance with the principles of the present invention.

FIG. 2 is a schematic flow diagram illustrating a preferred method of creating a group setting within the method network in accordance with the principles of the present invention.

FIG. 3 is a schematic flow diagram illustrating a preferred method to participate in the method in accordance with the principle of the present invention.

FIG. 4 is a schematic flow diagram illustrating a preferred method of distributing operating and insurance expenses from the user contributions.

FIG. 5 is schematic flow diagram illustrating a preferred method of reporting information to the credit repositories on behalf of the network users.

FIG. 6 is schematic flow diagram illustrating another variation of the preferred method when managing late users.

FIG. 7 is schematic flow diagram illustrating another variation of the preferred method when managing default network users.

FIG. 8 is schematic flow diagram illustrating a preferred method of completing the method.

### DETAILED DESCRIPTION OF THE PREFERRED EMBODIMENT

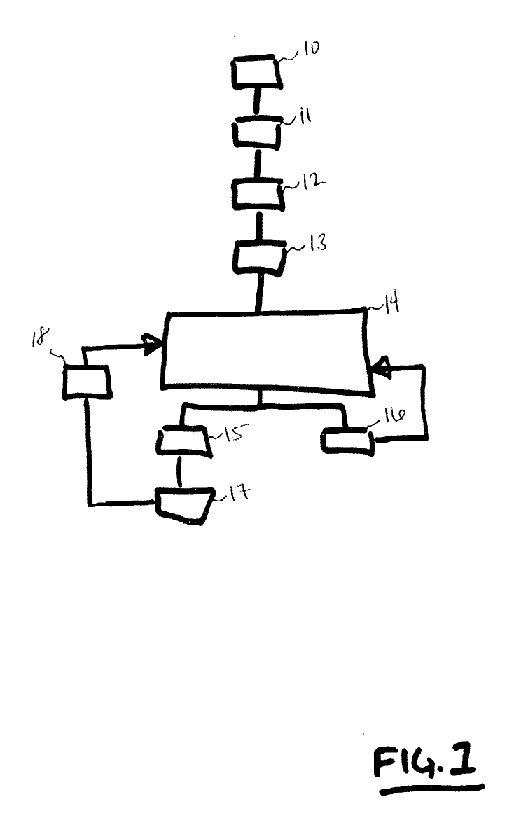

Turning now to the drawing, in which like reference characters indicate corresponding elements, attention is directed to FIG. 1 in which the method 10 begins by finding a location to house 11 the method hardware, such as company servers and/or any micro-processor based machines 12. A server is a micro-processor based machine that will store the method 10 and any pertinent data required to facilitate the method 10. The servers 12 will also allow the method 10 to communicate 13 with other micro-processor based machines 12 and thus create a network 14 for the method 10. The method's network 14 may consist of a plurality of user's 15 and/or third party companies 16 accessing the network 14 via their individual micro-processor based machine 12.

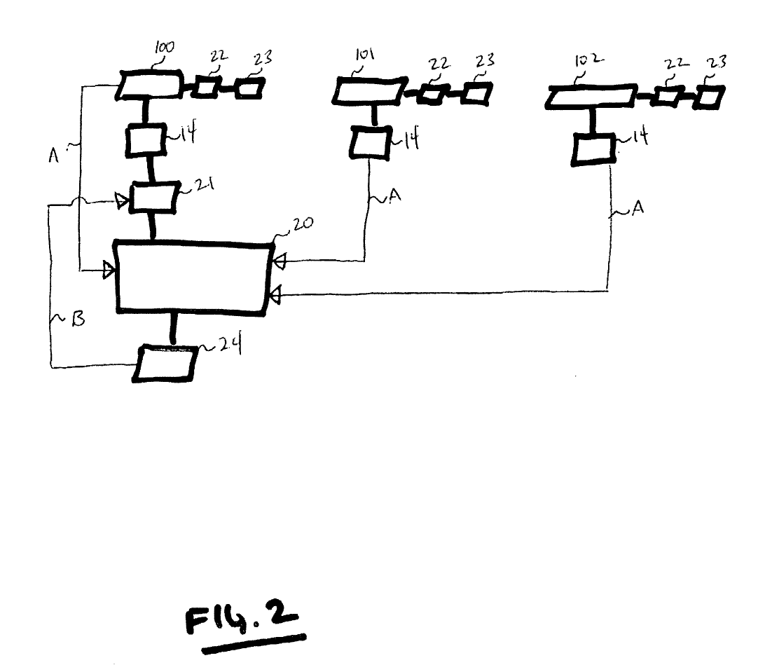

The public will be notified 17 of the availability to access the network 14 and participate in the method 10. This can be accomplished by television media, print media, word of mouth or any other reasonable means of informing people that the method network 14 is available for use. The public will subsequently access 18 the network 14 and form peer-selected groups 20 (FIG. 2) of any plurality to directly participate in the method 10.

Turning your attention to FIG. 2, in this variation, user 100 connects to the network 14 and creates a unique group setting 20 within the network 14, thus becoming the group setting coordinator. User 100 decides upon variables 21 for the method 10 (FIG. 1) which make the method 10 (FIG. 1) unique to this group setting 20 and which may include disbursement amount, length of interval, number of intervals and minimum risk rating standards 21. Each user will have their user data & history 22 stored on the servers 12 (FIG. 1). This data can be used to generate a network user's unique proprietary risk rating(s) 23 visible to all users within the network 14. The proprietary risk rating(s) 23 will help users 15 (FIG. 1) determine the associated risk of other prospective users 15 (FIG. 1) in helping to determine acceptance into their peer-selected group 20. Users 15 (FIG. 1) are encouraged to achieve a positive risk rating in order to represent a low risk to other network users 15 (FIG. 1). This unique group setting 20 created by user 100 will then be available to all users 15 (FIG. 1) to participate in this particular group setting 20.

User 100, user 101 and user 102 connect to the network 14 and congregate into the group setting 20 created by user 100 indicated by arrowed lines A. Users on the network 14 can create a unique group setting 20, such as user 100, or participate in a currently existing and/or open group setting 20 within the method network 14, such as user 101 and user 102. According to the settings defined by the coordinator 100 the group setting 20 will be closed after user 100, user 101 and user 102 are a part of this group setting 20 and the group will no longer be accepting additional users 15 (FIG. 1).

A group setting fingerprint 24 will subsequently be created for this group setting 20. This unique fingerprint 24 will be used to keep track of the method variables 21 on the servers 12 (FIG. 1) as indicated by arrowed line B, i.e. group setting users, interval contribution, start/stop date, disbursement amount, number and length of intervals and disbursement order.

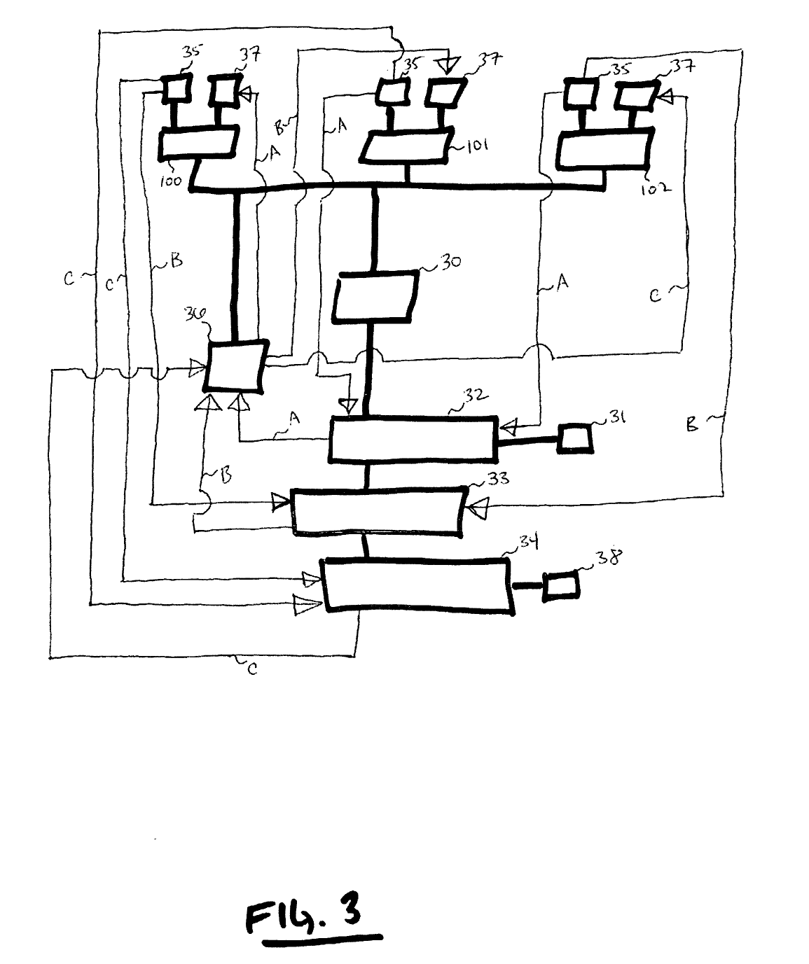

Turning to FIG. 3, user 100, user 101 and user 102 are asked to agree to this group setting variation 20 (FIG. 2) and commit 30 to the method 10 (FIG. 1), thus locking them into a commitment for the period between the start 31 and stop 38 dates predefined by the group setting 20 (FIG. 2).

User 100, user 101 and user 102 of this group setting 20 (FIG. 2) will contribute a fixed amount of a commodity at the agreed upon interval with the predefined start 31 and stop date 38.

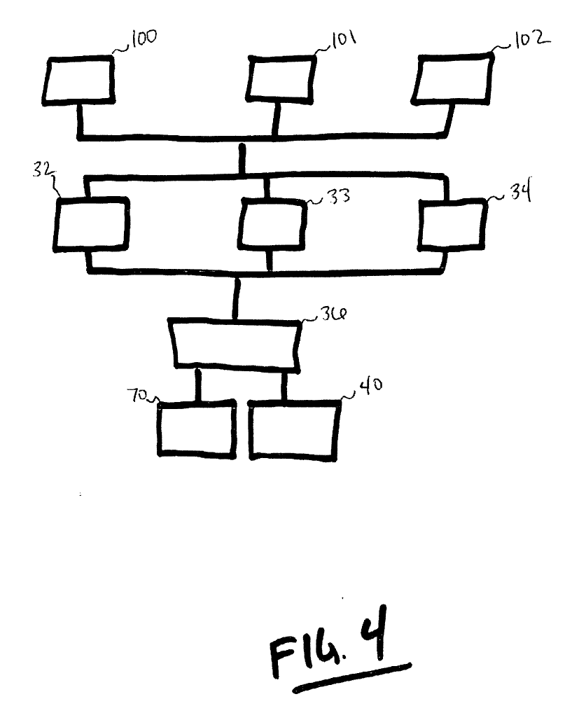

Briefly turning to FIG. 4, a percentage of every contribution will go towards company operating expenses 40 and insurance premiums 70. The insurance 70 is used to protect the users in case any plurality of the users in a group setting 20 (FIG. 2) default on their commitment 30 (FIG. 3). This insurance 70 can either be an outside third party company, an in-house self insured variation or another user within the network.

Returning to FIG. 3, User 100, user 101 and user 102 will take turns at each interval receiving the full collected contribution until all users have received their lump sum, also known as the disbursement. Depending on the interval in which user 100, user 101 and user 102 receive their disbursement, they will alternate between being lenders and borrowers. The disbursement order in which the users receive their disbursement is decided upon by the group at the start date 31 of each method 10 (FIG. 1) and may be determined by lottery, mutual agreement, user risk or any other reasonable method.

The first interval 32 of this method will commence immediately on the start date 31. Based on these specific group settings 20 (FIG. 2) predefined disbursement order, users 101 and user 102 will have their first interval contribution collected from their preferred contribution location 35 and then deposited into a company secure location 36 indicated by arrowed lines A. All users will predefine their preferred contribution location 35 from which the method will collect their interval contribution. The preferred contribution location can be a specific physical location, a commodity cache or any other acceptable secure location. Similarly, the company secure location 36 can be a specific physical location, a commodity cache or any other acceptable secure location.

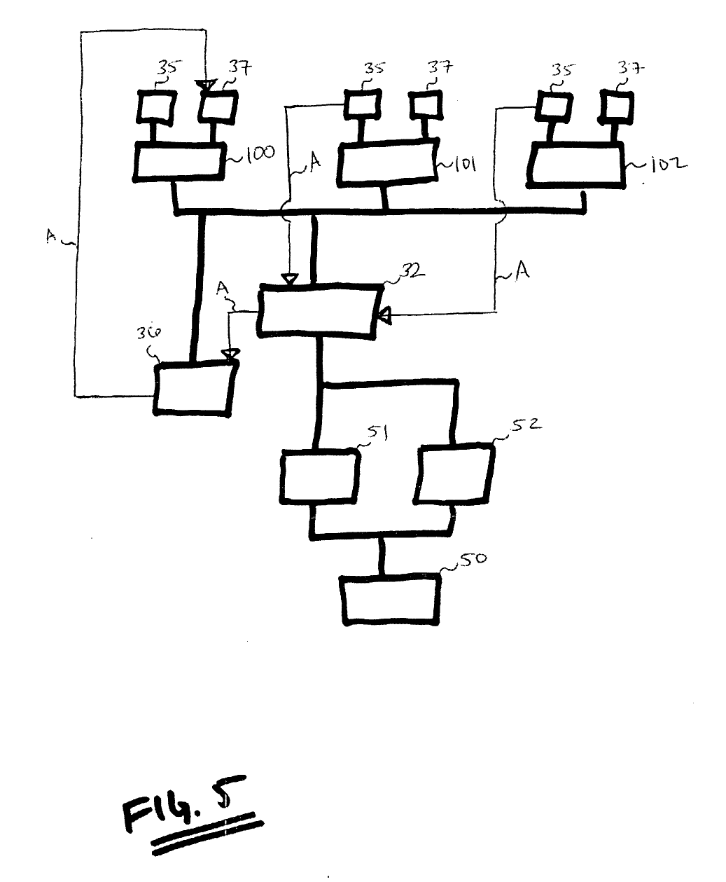

Turning to FIG. 5, if the user(s) contributions are collected on schedule as indicated by arrowed lines A, a positive mark 51 will be reported to the credit repositories, Experian, Equifax, Transunion or any other acceptable third party credit bureau 50, on the user's behalf.

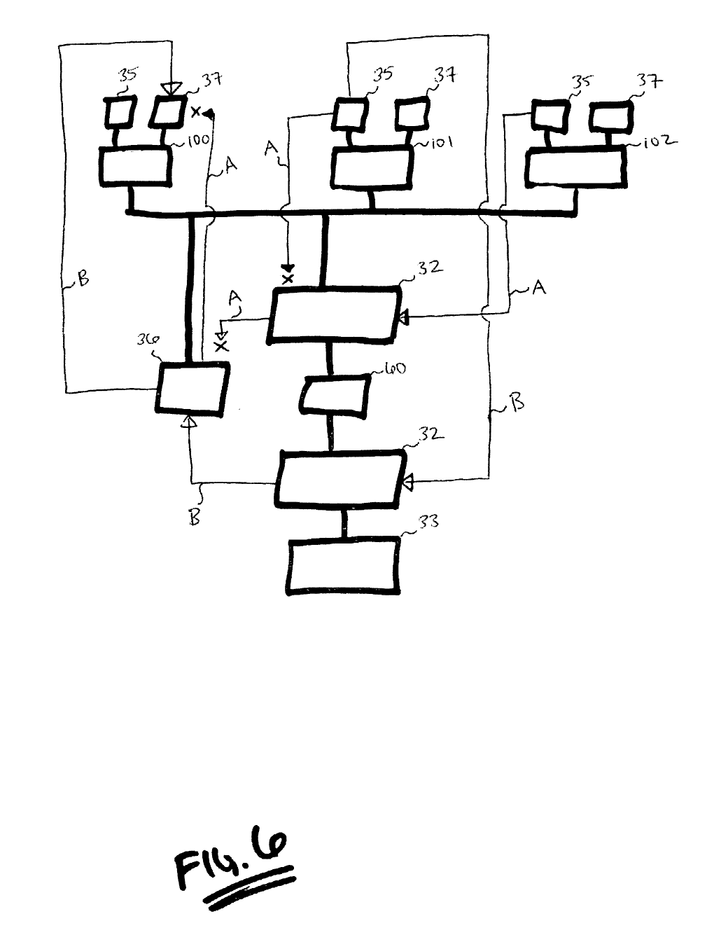

Turning to FIG. 6 shows that if the method 10 (FIG. 1) is unable to collect the interval contribution from user 101 and/or user 102′s preferred contribution location 35 at the scheduled interval indicated by arrowed lines A, the disbursement to user 100 will be held for the previously accepted grace period 60 also indicated by arrowed lines A. The method 10 (FIG. 1) will repeatedly attempt to collect the scheduled interval contribution from the tardy users, specifically user 101 and/or user 102. If the method 10 (FIG. 1) is able to collect the interval contribution from the tardy users within the grace period 60 indicated by arrowed lines B, the contribution will be deposited into the company's secure location 36 also indicated by arrowed lines B. Quickly turning to FIG. 5, a positive mark 51 will be reported to the credit repositories 50 for the user(s).

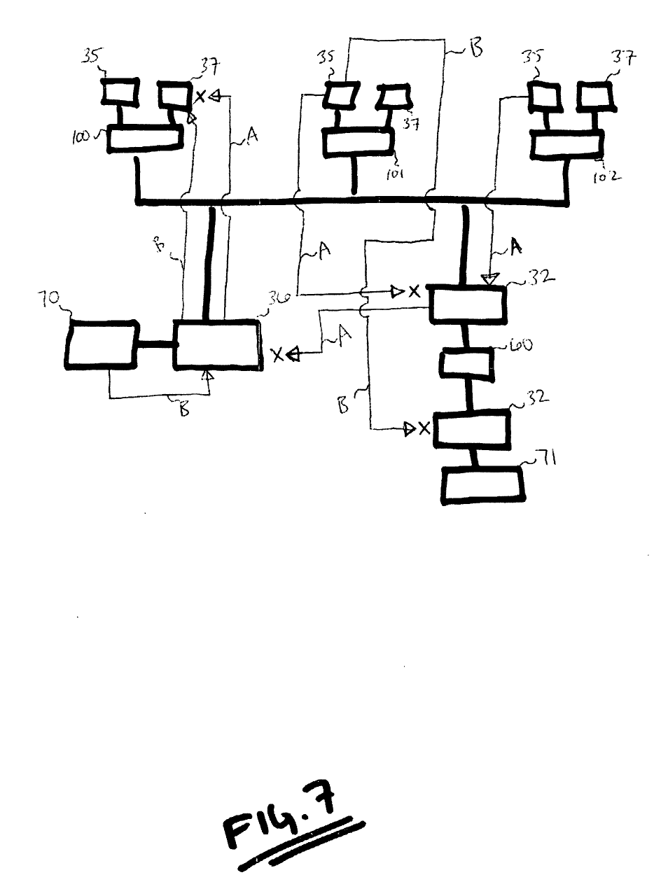

Now turning to FIG. 7, if the method 10 (FIG. 1) is unable to collect the contribution from user 101 and/or user 102′s preferred contribution location 35 during the grace period 60, indicated by arrowed lines A, the insurance 70 will deposit the delinquent contribution into the company secure location 36 indicated by arrowed lines B, and the delinquent user(s), specifically user 101 and/or user 102, will be removed 71 from the group setting 20 (FIG. 2) and will subsequently have a chance to redeem themselves by contributing a penalty. Looking to FIG. 5, the delinquent user 101 and/or 102 will have a negative mark 52 reported to the credit repositories 50.

Returning to FIG. 7, the insurance 70 will take the place of the delinquent user(s) 101 and/or user 102 in the group setting 20 (FIG. 2) for the remainder of this specific method 10 (FIG. 1).

Turning back again to FIG. 3, user 100 will receive the predefined disbursement once all necessary contributions are collected in the company secure location 36 as indicated from arrowed lines A, from any combination of user 101, user 102, or the insurance 70 (FIG. 7). The method 10 (FIG. 1) will deposit the disbursement into user 100′s previously selected disbursement secure location 37 as indicated by arrowed lines A. All users will predefine a secure location 37 for their disbursement. This secure location can either be a specific physical location, a commodity cache or any other protected location. This concludes the first interval 32 of this specific group's method 10 (FIG. 1).

Continuing on FIG. 3, the second interval 33 of this specific group's method, all users in this group setting 20 (FIG. 2) have shifted one position where user 101 is now due the disbursement. All other users of the group; specifically user 100 and user 102 make their interval contribution, indicated by arrowed lines B. Any and all previously mentioned grace periods and insurance protection against tardy or default users will be applied, as necessary, for every interval in a group setting 20 (FIG. 2).

Continuing on FIG. 3, the schematic diagram represents the final interval 34 on the stop date 38 of the specific group's method. All users in this group setting 20 (FIG. 2) have shifted one position where user 102 is now due the disbursement, indicated by arrowed lines C. All other users of the group; specifically user 100 and user 101 make the final interval contribution, also indicated by arrowed lines C.

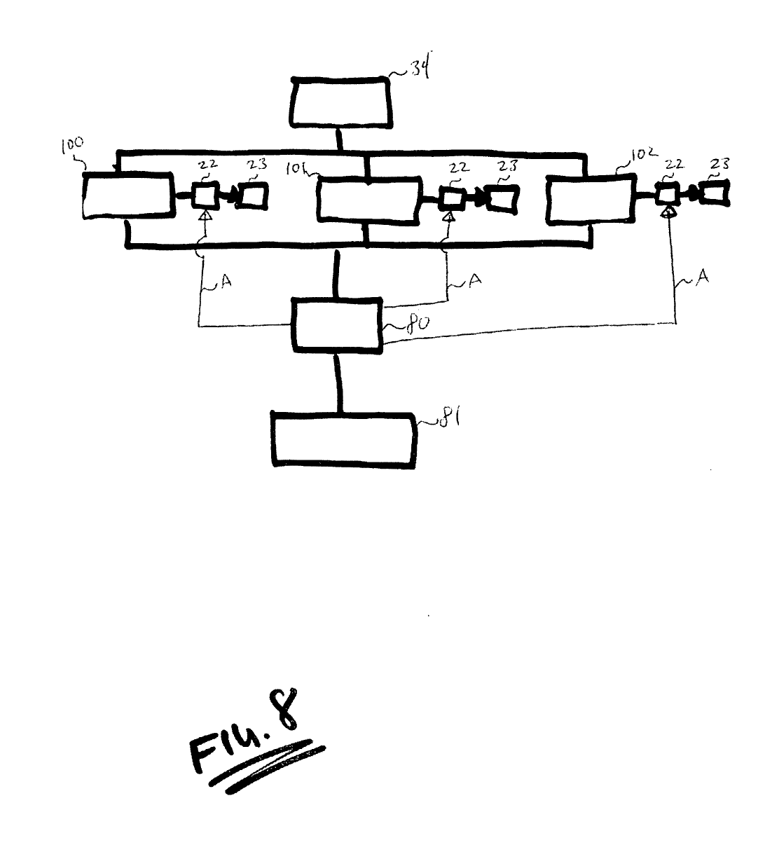

Turning to FIG. 8, this is a schematic diagram representing the completion sequence for this group which will commence immediately following the final interval 34. The completion sequence encompasses an accountability system and a user commitment release 81. The accountability system will have user 100, user 101 and user 102 perform a peer evaluation 80 of the other users in this group setting 20 and/or the company servers 12 (FIG. 1) will perform an automated evaluation 80. The peer evaluation and/or automated evaluation 80 will evaluate the users in this specific group, indicated by arrowed lines A, with respect to the quality of the commodity being contributed, timely or untimely contribution habits, or their respect for their fellow users.

The information collected via the accountability system will update the user data and history 22 for user 100, user 101 and user 102 on the company server 12 (FIG. 1) in order to update their individual proprietary risk ratings 23.

User 100, user 101 and user 102 are now released 81 from their commitment to this group setting 20 (FIG. 2) and are free to exit the network 14 (FIG. 1) or participate in a new method 10 (FIG. 1).

For purposes of illustration, only three users were shown directly participating in the method 10 (FIG. 1); however the method 10 (FIG. 1) will always have the necessary intervals required to accommodate any plurality of users 15 (FIG. 1) within the method network 14 (FIG. 1) and more specifically, in any unique group setting 20 (FIG. 2).

The users within the method network 14 (FIG. 1) may have the option of actively participating in more than one group setting 20 (FIG. 2) at a time and/or the option of receiving more than one disbursement per unique group setting 20 (FIG. 2) so long as the corresponding number of contributions are made per interval.

What is claimed is:

1. Use of microprocessor machines over an online network to allow users to participate in Rotating Savings and Credit Associations (ROSCAs) in order to meet an individual's financial needs through the use of cooperation.

2. Electronic Fund Transfer (EFT) of all withdrawals and deposits associated with users ROSCA accounts.

3. Proprietary Risk Ratings enabling scalability of proposed invention.

4. Credit reporting of all user transactions to the Experian, Equifax, and Transunion credit bureaus.

5. Online use of group setting for modernization of ROSCAs.
